(19) United States
(12) Patent Application Publication
(10) Pub. No.: US 2025/0037044 A1
(43) Pub. Date: Jan. 30, 2025

(54) SYSTEMS AND METHODS FOR OPTIMIZING NAVIGATION FOR AN IN-PERSON TRIP

(71) Applicant: Capital One Services, LLC, McLean, VA (US)

(72) Inventors: Eric SCHULTZ, Trappe, PA (US); Mohamed SECK, Aubrey, TX (US); Joseph SCHOLZ, Bear, DE (US)

(73) Assignee: Capital One Services, LLC, McLean, VA (US)

(21) Appl. No.: 18/359,201

(22) Filed: Jul. 26, 2023

(51) Int. Cl. G06Q 10/047; G01C 21/34; G06Q 10/087; G06Q 30/0601; H04W 4/029

(52) U.S. Cl. CPC G06Q 10/047; G01C 21/343; G06Q 10/087; G06Q 30/0639; H04W 4/029; G06Q 50/40

(57) ABSTRACT

A method for planning and/or optimizing an in-person trip includes: determining, based on a user interaction between a user and a user device, that the user has an in-person-action intention associated with a particular location; obtaining a list of elements designated by the user for in-person action; identifying at least one entity associated with the particular location; determining at least one location at the at least one entity associated with at least one element on the list; generating directions that indicate a path through the at least one entity and to the at least one location associated with the at least one element; receiving an indication from the user device that the user device has determined that the user has arrived at the at least one entity; and in response to receiving the indication, causing the user device to output the directions.

### TECHNICAL FIELD

Various embodiments of this disclosure relate generally to techniques for optimizing in-person trip planning, and, more particularly, to systems and methods for providing directions to different venues and/or item locations within a venue for efficient trip completion.

### BACKGROUND

When it comes to tasks like shopping, chores, or the like, time and convenience are often competing values. For example, conveniences provided by online shopping, e.g., less concern for the customer regarding inventory stock, access to many different vendors or entities, facilitation of comparison shopping, etc., are often mutually exclusive with conveniences provided by in-person shopping, e.g., obtaining items purchased without a shipping delay, co-location of a physical vendor with other locations of interest, ability to physically inspect items before purchase, etc. The conventional stratification between online and in-person actions generally results in each failing to benefit from the conveniences provided by the other.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for optimizing in-person trip planning.

In one aspect, an exemplary embodiment of a method for planning and/or optimizing an in-person trip may include: determining, via at least one processor and based on a user interaction between a user and a user device, that the user has an in-person-action intention associated with a particular location; obtaining, via the at least one processor, a list of elements designated by the user for in-person action; identifying, via the at least one processor, at least one entity associated with the particular location; determining, via the at least one processor, at least one location at the at least one entity associated with at least one element on the list; generating, via the at least one processor, directions that indicate a path through the at least one entity and to the at least one location associated with the at least one element; receiving, via the at least one processor, an indication from the user device that the user device has determined that the user has arrived at the at least one entity; and in response to receiving the indication, causing the user device to output the directions.

In another aspect, an exemplary embodiment of a computer-implemented method for optimizing an in-person trip may include: detecting, via at least one processor of a user device, an interaction between a user and the user device indicative that the user has an in-person action intention associated with a particular location; transmitting, via the at least one processor and to a server system, an indication of the detecting of the interaction; receiving, from the server system, directions that indicate a path through at least one entity associated with the particular location and to at least one location associated with at least one element from a list of elements designated by the user for in-person action; detecting, via the at least one processor, that the user has arrived at the at least one entity; and in response to detecting that the user has arrived, causing a display of the user device to output the directions.

In a further aspect, an exemplary embodiment of a computer-implemented method for optimizing an in-person trip may include: determining, via at least one processor and based on a user interaction between a user and a user device, that the user has an in-person-action intention associated with a particular location; obtaining, via the at least one processor, a list of elements designated by the user for in-person action, wherein the list of elements is obtained from one or more of an online universal element listing associated with the user or element listing data included in an electronic application user profile associated with the user; identifying, via the at least one processor, at least one entity associated with the particular location, wherein one or more of the identification of the at least one entity or the directions is optimized based on one or more of: minimizing a total predicted trip time; a maximum constrain on the total predicted trip time; minimizing a total predicted trip distance; minimizing a total predicted trip cost; minimizing a total number of entity visits in the in-person trip; maximizing a total number of elements from the list of elements included in the in-person trip; or one or more user-selected destinations to be included in the in-person trip; and determining, via the at least one processor, at least one location at the at least one entity associated with at least one element on the list; generating, via the at least one processor, directions that indicate a path through the at least one entity and to the at least one location associated with the at least one element; receiving, via the at least one processor, an indication from the user device that the user device has determined that the user has arrived at the at least one entity; and in response to receiving the indication, causing the user device to output the directions.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for planning and/or optimizing an in-person trip, according to one or more embodiments.

FIG. 2 depicts a flowchart of an exemplary method of planning and/or optimizing an in-person trip, according to one or more embodiments.

FIG. 3 depicts an example of a computing device, according to one or more embodiments.

### DETAILED DESCRIPTION OF EMBODIMENTS

According to certain aspects of the disclosure, methods and systems are disclosed for techniques for optimizing in-person trip planning, and, more particularly, to systems and methods for providing directions to different venues and/or item locations within a venue for efficient trip completion

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” “venue,” or the like generally encompass an entity or person involved in providing, selling, and/or renting items to persons such as a seller, dealer, renter, merchant, vendor, or the like, as well as an agent or intermediary of such an entity or person. An “item,” “element,” or the like generally encompasses a good, service, or the like having ownership or other rights that may be transferred. As used herein, terms like “user,” “person,” or “customer” generally encompasses any person or entity that may desire an item, information, or any other suitable type of interaction with an entity. The term “browser extension” may be used interchangeably with other terms like “program,” “electronic application,” or the like, and generally encompasses software that is configured to interact with, modify, override, supplement, or operate either independently or in conjunction with other software, e.g., as a client operating with a server or the like.

Conventionally, a person desiring an item may choose between obtaining the item online, e.g., via an e-commerce website, or in person at a physical vendor. Obtaining the item online may result in the person needing to wait for delivery, obtaining an item that was different than it appeared online, and encountering difficulty executing a return or requesting service. Obtaining the item in person may result in the person needing to travel to the physical vendor, finding out after traveling that the desired item is out of stock, or the person missing out on savings from obtaining the item elsewhere. Such concerns may be compounded when multiple items are desired, which may result in the person needing to visit multiple vendors. Thus, further advancement in techniques for efficient trip-planning and/or item obtainment are needed.

In an exemplary use case, a user may desire to obtain one or more items in-person. The user may, for example, add one or more items to a list designated for in-person action. A smart-trip application, e.g., with a client instance operating on a user device associated with the user (such as a mobile phone) and a server instance operating on a server system, may determine that the user has the intention of performing one or more in-person actions associated with a particular location. For example, the smart-trip application may receive an instruction from the user regarding a current or planned trip. In another example, the smart-trip application may determine that the user is approaching the particular location. In a further example, the smart-trip application may predict, e.g., based on user history information, that the user is likely to desire an item available at a vendor associated with the particular location, or is likely to take a trip to the particular location.

In response to determining the intention of the user, the smart-trip application may obtain the list of items designated by the user for in-person action. The smart-trip application may identify one or more vendors associated with the particular location that are known and/or predicted to provide one or more items from the list. The smart-trip application may determine locations at the one or more vendors associated with the one or more items, e.g., a section, aisle, shelf, floor, or other location information. The smart-trip application may generate directions for the user, e.g., that include an indication of a path for the user to follow through the one or more vendors to obtain the one or more items from the list. In response to determining that the user is approaching or has arrived to at least one of the vendors, the smart-trip application may cause the user device to output the generated directions. As the user moves and/or obtains items from the one or more vendors, the smart-trip application may cause the directions to be updated.

In various instances, the selection of the one or more vendors and/or the directions between vendors and/or items may be optimized based on one or more criteria such as, for example, minimizing a total predicted trip time, a maximum constrain on the total predicted trip time, minimizing a total predicted trip distance, minimizing a total predicted trip cost, minimizing a total number of vendor visits in the in-person trip, maximizing a total number of items from the list of items included in the trip; and/or one or more user-selected destinations to be included in the in-person trip.

For instance, a person may have a schedule that provides a limited amount of time to complete one or more tasks. In an example, a parent may drop off a child at an activity, and may only be free for a fixed amount of time until the child needs to be picked up. The person, e.g., via a client instance of a smart-trip application operating on a user device, may indicate an intention to do in-person shopping with criteria of returning to the child's activity within the fixed amount of time. The smart-trip application may access a list of items associated with the person and/or the person may add or edit the list when making the indication. The smart-trip application may identify one or more entities near the activity that provide one or more of the items on the list, and may generate a plan for a trip, e.g., that includes directions to one or more entities and/or to the one or more items within the entities (e.g., aisle number, location, section etc.). In some instances, the smart-trip application may access inventory information from the entities and/or from crowd-sources information such as other users of the smart-trip application. The directions may be generated so as to route the person back to the activity within the fixed amount of time, and/or may be generated so as to maximize a number of items on the list that may be obtained before the fixed amount of time expires.

Such optimization may include which entities are selected, a route between entities, a route within entities to one or more items, etc. In some instances, the smart-trip application may track progress in obtaining items on the list, e.g., compared to the plan for the trip, and may modify or update the trip. For example, additional items may be added if a stage of the trip takes less time than predicted, or one or more items may be removed or replaced if a stage of the trip takes longer than predicted. Tracking progress may be based on tracking a location of the user device, user feedback such as marking an item as obtained, the user scanning or taking a photo of an item or item information, or the like. Such information may also be used to crowd-source item location information for other users of the smart-trip application.

In another instance, a user may arrive at a multi-vendor location such as a strip-mall or the like. Upon detecting an in-person shopping intention for the user, e.g., based on one or more of detecting the arrival of the user to the location, detecting entry of the user into one or more of the vendors, an analysis of user history information such as shopping habits and/or items on the user's list, a smart-trip application may identify vendors that offer one or more items on the list and generate a plan, e.g. directions, for the trip. In some cases, multiple vendors at a location may offer the same or similar items. The smart-trip application may optimize the trip by selecting at which vendor an item offered at multiple vendors should be obtained. For example, vendors may be selected to offer a best price to the user and minimize a total cost for the trip, and/or may be selected for an efficient route between and/or within the vendor(s), e.g., to minimize trip time, total walking distance, or the like.

In some instances, the smart-trip application may be configured to pre-purchase one or more items at one or more of the identified vendors. For example, the smart-trip application may execute pick-up or to-go orders, such that the user may pick up items from the list from a vendor without having to navigate to each item individually.

In some instances, the smart-trip application may be configured to operate in conjunction with an electronic wallet or other payment device of the user. For example, as the user enters different vendors, the smart-trip application may be configured to ready a payment mechanism (e.g., configure a Near-Field Communications array for use) on the user device with a payment method particular to each vendor. For instance, a user may have coupons, membership rewards, or other benefits that are applicable to a particular vendor or vendors, and the smart-trip application may be configured to automatically apply or enable use of such benefits for each vendor visited by the user.

In some instances, different vendors identified as providing items on the list may be at different locations requiring travel there-between. Such travel may, in some cases, be associated with additional cost such as gasoline costs, parking costs, toll costs. Travel time and/or travel costs may be accounted for when planning or optimizing a trip. For example, vendor A may offer a product for $5.00, while vendor B may offer the same product for $4.97. While vendor B would appear to provide a $0.03 savings, travelling to vendor B may incur an additional $0.25 in gas charges based on current gas prices and distance of travel, such that the apparent savings is actually a $0.23 loss.

In a further instance, a person may have a fixed appointment during a period of time otherwise available for completing tasks. For example, a person may have a doctor's appointment in an hour, but then has time afterwards. The user may enter the appointment time and location into a smart-trip application, e.g., via a user device. The smart-trip application may generate a plan for a trip, e.g., directions, which includes travel to one or more vendors before the appointment, the appointment itself, and travel to one or more vendors after the appointment. For example, the smart-trip application may identify one or more vendors along the way to the appointment at which the user may obtain a few items from the list, with additional items/vendors scheduled for after the appointment.

In another instance, multiple users may cooperate to obtain items on a list. In some cases a user may sub-divide a list for distribution to at least one additional user. In some cases, the smart-trip application may automatically sub-divide a list, e.g., for efficient division of labor between the users. For example, different users may be directed to different vendors or sections of vendors, e.g., to minimize total trip time, cost, or the like. In some instances, the smart-trip application may account for the users meeting up at a conclusion of the trip, or needing to share a particular number of vehicles between vendors, or the like.

In another instance, a user may plan a trip and/or be at a theme park, and desires to ride as many roller-coasters as possible before the theme park closes. A smart-trip application may obtain ride wait-time information and ride location information from the theme park and/or from crowd-sourced information, and may generate a plan, e.g., directions, that takes such information into account to optimize a route for the user to access a maximum number of rides while the theme park is open.

In a further instance, a user may be at a concert venue, e.g., at an assigned seat or section. The user may desire to obtain various items, e.g., food, a souvenir, a tee-shirt, etc., without missing out on as little of the concert as possible. The smart-trip application may obtain information related to vendors at the concert venue and or items offered by the vendors, and the user may indicate, e.g., via a user device, one or more items to be obtained. The smart-trip application may generate a plan, e.g., directions, to one or more vendors to obtain the desired items. The smart-trip application may take into account factors such as distance, predicted time to purchase an item, information regarding the concert such as an intermission or set schedule, or the like.

While several of the examples above involve shopping or obtaining items from a vendor or entity, it should be understood that techniques and technologies disclosed herein may be adapted to any suitable activity such as, for example, navigating to various booths in a convention, stores in a mall, work locations at a jobsite, inventory stock locations in one or more warehouses, residences (e.g., for deliveries or trick-or-treating, or the like), etc.

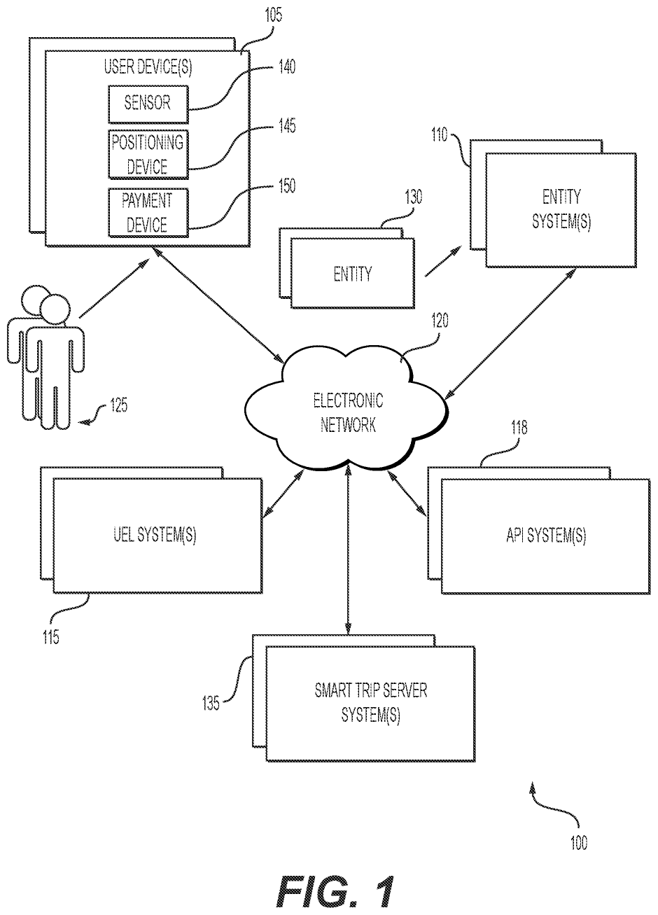

FIG. 1 depicts an exemplary environment 100 that may be utilized with techniques presented herein. One or more user device(s) 105, one or more entity system(s) 110, one or more Universal Element List (“UEL”) system(s) 115, and one or more Application Programming Interface (“API”) system(s) 118 may communicate across an electronic network 120. Although one or more user device(s) 105, entity system(s), etc., may be included in various embodiments, for simplicity of description, such elements are referred to in the singular. Any number of such elements may be used in various embodiments. The user device 105 may be associated with a user 125. The entity system 110 may be associated with an entity 130. As discussed in further detail below, one or more smart-trip server system(s) 135 may be in communication with one or more components of environment 100, e.g., via network 120.

In some embodiments, one or more of the components of the environment 100 are associated with a common entity, e.g., a financial institution, smart assistant service or application, merchant, or the like. In some embodiments, one or more of the components of the environment 100 is associated with a different entity than another. The systems and devices of the environment 100 may communicate in any arrangement. As will be discussed herein, systems and/or devices of the environment 100 may communicate in order to one or more of plan an in-person trip, optimize in-person trip planning, provide directions to different venues and/or item locations within a venue, or the like.

The user device 105 may be configured to enable the user 125 to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105. In some embodiments, the electronic application(s) may be associated with one or more of the other components in the environment 100. For example, the electronic application(s) may include one or more of a shopping portal associated with an entity system 110, a UEL system 115, a smart-trip server system 135, etc.

The user device 105 may include a sensor 140 such as, for example, one or more of a camera, barcode scanner, infra-red sensor, RFID sensor, or the like. The user device 105 may include one or more of a positioning device 145, e.g., a Global Positioning Sensor (“GPS”) device, a wireless antenna usable for location sensing or location data such as a cellular antenna, Bluetooth antenna, wireless network antenna, or the like. The user device 105 may include one or more of a payment device 150, e.g., a NFC device, an RFID antenna, or the like. The user device 105 may include any suitable type of interface for interacting with the user 125, e.g., a touch-screen, a speaker, a micro-phone, one or more buttons, etc.

The user device 105 may store and/or operate an electronic application, e.g., a client instance of a smart-trip application configured to operate in conjunction with the smart-trip server system 135 as discussed in further detail below. The smart-trip application may include a Graphical User Interface (“GUI”) configured to facilitate interaction with the user 125. For example, the GUI may be configured to enable the user 125 to add or edit items on a list of items associated with the user 125. In some instances, the GUI may enable the user 125 to perform a search for items, e.g., via data obtained from or access with the entity system 110, the UEL system 115, the API system 118, or the like. In some instances, the GUI may be configured to receive information pertaining to a trip, e.g., a current location of the user device 105, a future start location for a trip, appointment information, constraints or criteria for a trip such as a limit or criterion associated with time, cost, distance, number of vendors, number of users participating, trip end time, coupons or memberships to apply, etc.

In some instances, the smart-trip application may operate in conjunction with the UEL system 115. For example, the UEL system may store and/or maintain the list associated with the user 125, and the smart-trip application may access and/or update the list on the UEL system 115. In some instances, the smart-trip application may obtain other information from the UEL system 115 such as, for example, user history information, coupons or benefits available at various vendors, memberships or benefits associated with the user 125, etc. In some instances, the smart-trip application may be configured to obtain data from one or more of the sensor 140 or the positioning device 145. For example, the user device 150 may capture item information, item location information, or the like during a trip via the sensor 140 and/or the positioning device 145. Such capture may be in the form of, for example, a photo of an item taken by the user 125 via the user device 105, a scan of a barcode or the like taken by the user 125 of an item, a photo of a receipt taken by the user 125, a location from the positioning device 145 in conjunction with an indication that an item has been obtained, or the like. The indication that the item has been obtained may include one or more of a user interaction received by the GUI, capture of item information via sensor 140, proximity of a location of the user device 105 via the positioning sensor 145 to a location associated with the item, or the like.

The entity system 110 may include a server system or other computing device associated with an entity 130. In some embodiments, the entity system 110 may store and/or make available over network 120 information regarding items provided by the entity 130 such as, for example, categories of items provided, a listing of items provided, inventory availability information, and/or item location information. Item location information may include, for example, a section, aisle, shelf, or other location associated with a category of items and/or a particular item. In some instances, such information may include a map, a directory, or the like. The entity system 110 may store and/or make available other information such as address information or schedule information for the entity 130.

The UEL system 115 may include a server or other computing device, and may implement and/or provide services related to a universal elements list, e.g., a universal shopping cart. For example, the UEL system 115 may be associated with one or more online merchant websites, one or more electronic applications and/or one or more browser extensions, or the like, by which the user 125 may add items to a universal list associated with the user. The universal list may include item data with or without an association to a vendor at which the item may be provided. The UEL system 115 may store user information, e.g., historical information regarding items obtained by the user 125 as well as information regarding when, where, or how such items were obtained. The UEL system 115 may store other information such as payment method information, coupon information, membership reward or other benefit information, or the like. In some instances, the UEL system 115 may be configured to obtain trip information and/or transaction information associated with items obtained by the user 125. Such information may include, for example, indications of items obtained, receipt information, payment information, transaction information, coupons, benefits, or memberships used or acquired, or the like. The UEL system 115 may be configured to update the list associated with the user 125 based on such information.

The API system 118 may include a server or other computing device, and may be configured to receive and respond to a request for information or the like. For example, the API system 118 may include a similar item finder service configured to receive information indicative of an identity of an item, determine one or more items likely to be similar to the item, and provide such information back to the requesting system or entity. For instance, a user 125 may have added brand X of an item to a list, and a system such as the entity system 110, the UEL system 115, the smart-trip system 135, or the like may request one or more similar items to be identified by the API system 118, e.g., brand Y of the item or brand X of a similar item, etc.

In another example, the API system 118 may include a directions service configured to determine directions between various locations. The API system 118 may be configured to account for or optimize for one or more criteria or constraint, such as total distance, total time, fixed appointments or locations, a selected start or end time, or the like. In some instances, one API system 118 may be used for directions to or from an entity, and another API system may be used for directions through an entity.

In a further example, the API system 118 may be configured to identify one or more entities 130 associated with a geographical location. For example, the smart-trip server system 135 or another system may request entities associated with a particular location (e.g., a current or historical location of the user, a location for a requested trip, etc.), and the API system 118 may identify and return information related to one or more entities at or near the particular location. In some instances, the API system 118 may additionally filter entities, e.g., based on items or categories of items included with the request. To provide such services or perform operations such as the foregoing examples, in various embodiments, the API system 118 may include one or more algorithms, machine learning models, or the like.

In another example, the API system 118 may be configured to obtain and/or parse financial information, payment information, or transaction information associated with the user 125. For instance, the API system 118 may be configured to obtain an electronic receipt associated with a vendor visited by the user 125 during a trip, e.g., from the entity system 110, from a use account associated with the user such as an email account, a profile, or the like, or from a financial account associated with the user such as a banking or credit card account. In another instance, the API system 118 may receive a photo of a receipt or other item information, and may be configured to parse such information to determine itemized transaction information, or the like. Such information determined via the API system 118 may be used, for example, when sourcing information about items provide by various entities, when updating or interacting with the list of items associated with the user 125, e.g., via the UEL system 115, or any other suitable purpose. In another instance, the API system 118 may parse information relating to a past transaction and obtain return information for an item previously purchased by a user. For example, the API system may determine that an item purchased by the user has a 30-day return period. The smart-trip server system 135 may be configured to generate a notification for the user device 105 indicating that a return for the item may be added to a trip so that the return may be completed prior to the end of the return period. In another example, a user may initiate a return, e.g., by requesting a return shipping label or submitting a request, whereby such return requires the user to physically drop of the item with an entity. The API system 118 may obtain information regarding the return request, whereby the smart-trip server system 135 may be configured to add or suggest adding the physical drop off to a trip.

In various embodiments, the electronic network 120 may be a wide area network (“WAN”), a local area network (“LAN”), personal area network (“PAN”), or the like. In some embodiments, electronic network 120 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The smart-trip server system 135 may be configured to operate in conjunction with an electronic application or browser extension or the like operating on the user device 105. The smart-trip server system 135 may store information associated with the user 125 such as profile information, historical transaction information, payment information, or the like. The smart-trip server system 135 may store information associated with an entity 130 and/or one or more items provided by the entity 130. For example, the smart-trip server system 135 may store inventory information, item category information, item location information, address information, schedule information, or the like for an entity 130. In some instances such information for the entity 130 may be obtained, e.g., from time to time, from the entity system 110. In some instances, such information for the entity 130 may be obtained via crowd-sourcing. For example, as discussed in further detail below, the user device 105 may capture item information and/or item location information during a trip. In another example, the smart-trip server system 135 may access online resources such as, for example, a website page associated with the entity 130, a news or social media website page that may include information associated with the entity 130, or the like.

The smart-trip server system 135 may include one or more modules or algorithms, e.g., for planning and/or optimizing a trip. For example, in some embodiments, the smart-trip server system 135 may include an algorithm or module for performing operations such as obtaining a list of elements associated with a user 125, identifying one or more entities 130 that are likely to provide one or more of the items on the list, generating and/or optimizing directions for the trip, or the like. In some instances, the smart-trip server system 135 may utilize the API system 118 to perform at least a portion of such operations. In some embodiments, the smart-trip server system 135 may include one or more machine-learning models configured to perform at least a portion of such operations.

Although depicted as separate components in FIG. 1, it should be understood that a component or portion of a component in the environment 100 may, in some embodiments, be integrated with or incorporated into one or more other components. For example, a portion of the smart-trip server system 135 or the UEL system 115 may be integrated into the user device 105 or the like. In another example, the entity system 110 may be at least partially integrated with smart-trip server system 135. In some embodiments, operations or aspects of one or more of the components discussed above may be distributed amongst one or more other components. Any suitable arrangement and/or integration of the various systems and devices of the environment 100 may be used.

In the following methods, various acts may be described as performed or executed by a component from FIG. 1, such as the smart-trip server system 135, the user device 105, the UEL system 115, or components thereof, and/or via software or an electronic application implemented thereon such as a smart-trip application. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner. Also, it should be understood that the following methods may include additional operations or actions taken by additional persons or devices, and that such inclusion is to further illustrate the techniques or technologies discussed herein, and is not limiting on any particular embodiment.

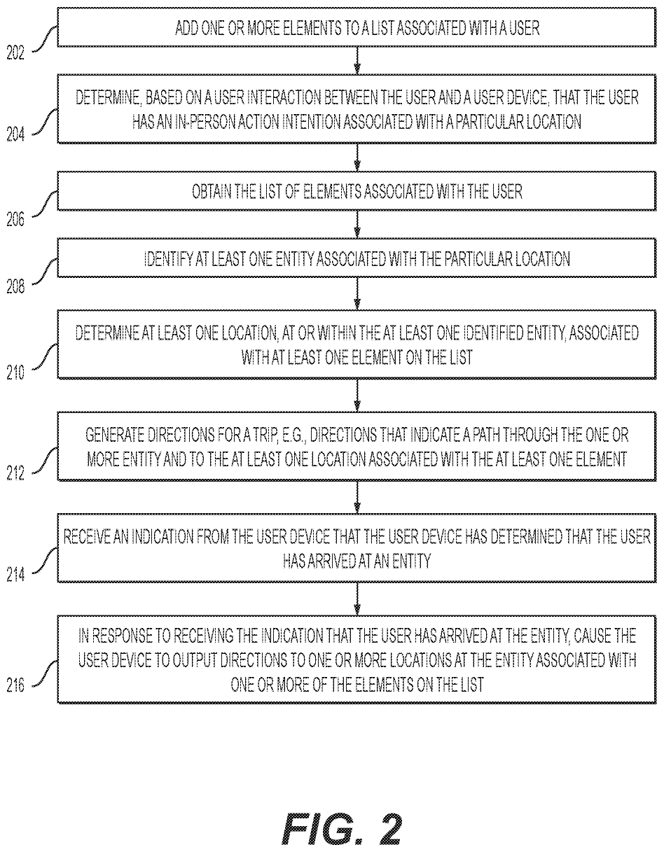

FIG. 2 illustrates an exemplary process for planning and/or optimizing an in-person trip. At step 202, a user 125 may add one or more elements to a list associated with the user 125. In some embodiments, the user 125 may add one or more elements by using a GUI of a client instance of a smart-trip application operating on a user device 105 to perform an element search. In some embodiments, the user 125 may add one or more elements by interacting with a browser extension that, for example, inserts an “Add to my List” button to an e-commerce website page visited via the user device 105. In some embodiments, the user 125 may add one or more items to the list from time to time. In some embodiments, the user 125 may add one or more items to the list in preparation for a current or planned trip. In various embodiments, the list may be stored and/or maintained by one or more of the user device 105, a smart-trip server system 135, a UEL system 115, or the like, such as in a user profile associated with the user. In some embodiments, the user 125 may specify one or more preferred brands or alternatives for one or more of the items on the list. In some embodiments, the user 125 may designate an item as whether or not substitution with a similar item is permitted. In some embodiments, the user may designate one or more items as for in-person action, for future action (e.g., a wish list), for online action, or the like.

At step 204, the smart-trip application, e.g., a client instance operating on the user device 105 and/or a server instance operating on the smart-trip server system 135, may determine, based on a user interaction between the user 125 and the user device 105, that the user 125 has an in-person action intention associated with a particular location. In some embodiments, the user interaction includes detecting, via a positioning device 145 of the user device 105, that the user 125 is travelling toward, approaching, or has arrived at the particular location and/or an entity at the particular location. In some embodiments, the user interaction includes a historical user action, e.g., that the user 125 is predicted to or has a history of making a trip to a particular location or entity at a particular time (e.g., a weekly grocery run), that the user 125 is predicted to or has a history of obtaining an item from a particular place and/or at a particular time (e.g., getting flowers prior to Valentine's Day), that the user has entered an appointment or event into an electronic schedule (e.g., a lunch date down by the mall), or the like. In some embodiments, the user interaction includes a user instruction, e.g., via the GUI pertaining to planning a current or future trip. For example, the user 125 may, via the GUI, enter trip information such as start time and/or start location. In some embodiments, the user 125 may request planning for a trip already in progress. For example, the user 125 may have started a trip without using the smart-trip application, and the smart-trip application may initiate a trip with a start location as the current location of the user 125.

In some embodiments, the user 125 may, via the GUI, enter criteria for the trip, e.g., one or more of end time, end location, mid-point location and/or time, total trip time, total trip distance, a minimization of one or more of trip time, trip distance, or trip cost, number of users participating in the trip and/or additional user information or sharing instructions, number of vehicles used for the trip, preference or inclusion of various modes of transport such as a vehicle, walking, bicycling, public transit, etc., or any other suitable criterion.

In some embodiments, the particular location may be based on the user instruction received via the GUI. In some embodiments, the particular location may be based on one or more of a current location of the user device 105 determined via the positioning device 145, a current direction of travel of the user device 105 detected by the positioning device 145, or user history data such as the historical user interaction(s) discussed above.

At step 206, the smart-trip application may obtain the list of elements associated with the user 125. In some embodiments, the list may be filtered, e.g., for items designated for in-person action. In some embodiments, the list may be obtained from an online location such as a user profile of the user 125 stored on the smart-trip server system 135, the UEL system 115, or the like. In some embodiments, the list may be obtained from a memory of the user device 105, e.g., associated with a client-side instance of the smart-trip application or another application such as shopping application, planning application or the like. In some embodiments, the list may be assembled from lists from multiple sources. In some embodiments, obtaining the list of elements includes determining one or more similar elements that correspond to one or more elements in the list. In some embodiments, the determining of similar elements is limited to elements designated as acceptable for substitution. In some embodiments, the determining of similar elements may be performed via a request to an API system 118 or the like.

At step 208, the smart-trip application may identify at least one entity 130 associated with the particular location. In some embodiments, the entity 130 may be identified based on a comparison of the list of elements with one or more of inventory information for the at least one entity 130 or item category information for the at least one entity 130. In some embodiments, the comparison accounts for one or more similar elements corresponding to one or more elements on the list. For example, the list associated with the user 125 may include an element such as “Brand X swim goggles-size M,” or may include a plurality of elements identified as similar thereto. The smart-trip application may access inventory information for a plurality of entities associated with the particular location, and identify one or more entities that list the item and/or similar items in their inventory. In another example, the list associated with the user 125 may include an element such as “Brand X swim goggles-size M,” and the smart-trip application, an API system 118, the UEL system 115, or the like may have determined that item to be in a category of “swimwear.” The smart-trip application may access inventory information for a plurality of entities associated with the particular location, and identify one or more entities that are associated with the category of “swimwear.”

In some embodiments, the smart-trip application may access inventory information stored on an entity system 110. In some embodiments, the smart-trip application may transmit a request to an API system 118 configured to track and/or obtain inventory information for various entities. In some embodiments, the smart-trip application may access inventory information stored on the smart-trip server system 135. For example, in some embodiments, the smart-trip server system 135 may receive crowd-sourced inventory information such as photos of elements at an entity, receipt information, transaction information, or the like from one or more users.

The smart-trip server system 135 may, in some embodiments, track such crowd-sourced information to identify items or categories of items provided by and/or in stock at various entities. The smart-trip server system 135 may, in some embodiments, use one or more of crowd-sourced information or inventory information accessed from any other suitable source to generate one or more in-stock inventory predictions for one or more entities. For example, a previous user may have provided crowd-sourced information indicating that Entity A provided them with “Brand X swim goggles-size L.” Based on such information, the smart-trip server system 135 or the like may predict that Entity A is more likely to have the element listed by the user 125, e.g., “Brand X swim goggles—size M.” In another example, the smart-trip server 135 may obtain crowd-sourced information indicative that a large number of users have recently purchased “Brand X swim goggles—size M” at Entity A, and thus may predict that Entity A is more likely to be out of stock of that particular item.

In some embodiments, when identifying the one or more entities 130 likely to provide the one or more elements on the list associated with the user 125, the smart-trip application may additionally obtain item information for one or more of the elements on the list such as, for example, price information coupon information, information regarding a membership held by the user 125 that may provide a benefit for the entity 130 and/or one or more of the elements on the list, or the like. In an example, the UEL system 115, an API system 118, or the like may be configured to track and accumulate one or more coupons for various elements at various entities.

In some instances, multiple entities may provide one or more of the elements on the list. In some embodiments, one or more entity may be identified in step 208 in favor of or instead of another based on a weighing of multiple factors. Factors may include, for example, whether the element offered by the entity is an exact match to a listed element, how similar an offered element is to a listed element, how many elements from the list are provided by the entity, the price of the element at the entity, a location of the item within the entity, a location of the entity, memberships or benefits available to the user 125 at the entity, etc. In some embodiments, such factors may be considered during optimization of a trip, as discussed in further detail below.

In some embodiments, an entity 130 may be identified for the trip based on detecting that the user 125 has arrived at a location associated with the entity 130. In other words, as noted above, in some embodiments, the user 125 arriving at, approaching, or entering an entity 130 may trigger the planning of a trip, whereby the trip may include the entity 130 arrived at by the user 125.

At step 210, the smart-trip application may determine at least one location, at or within the at least one identified entity, associated with at least one element on the list. For example, the smart-trip application may access inventory information, crowd-sourced information, entity information, or the like, to identify that an element from the list is provided in a particular department, in a particular aisle, at a particular shelf, and/or at a particular location within the identified entity. In some embodiments, the location may be particular to the element. In some embodiments, the location may be associated with a category of the element, e.g., an aisle for “swimwear” at a department store.

At step 212, the smart-trip application may generate directions for the trip. Such directions may include, for example, one or more of directions to the one or more identified entities, directions that indicate a path through the one or more entity and to the at least one location associated with the at least one element, to one or more other locations associated with the trip such as an appointment or destination, or the like. Directions, to an entity and/or through an entity, may be of any suitable form such as, for example, written instructions, a map with a visual indication of a path, a live map that shows a current location of a user device 105, augmented reality directions overlaid on a camera image of the user device 105, audio directions, via interaction with visual indicators associated with an entity such as path lighting, or the like. In some embodiments, the selection of entities for the trip and/or the generation of the directions is performed via or includes an optimization.

For example, there may be many options available for any particular trip such as which entity or entities to visit, which order in which to visit entities, which items to obtain at which entity, which order to obtain items within a particular entity, etc. In the event that multiple users are participating in the trip, there may be multiple ways to subdivide the list to efficiently obtain items therefrom. Additionally, as noted above, a trip may have one or more constraints, such as minimizing a total predicted trip time, a maximum constrain on the total predicted trip time, minimizing a total predicted trip distance, minimizing a total predicted trip cost, minimizing a total number of entity visits in the in-person trip, maximizing a total number of elements from the list of elements included in the in-person trip, or one or more user-selected destinations to be included in the trip. Further, there may be multiple ways to plan a trip to satisfy constraints on the trip such as total trip time, total trip costs, etc. For instance, a criterion for total trip cost or total trip time may result in less than all items on the list being obtained, and thus there may be many options for selecting which items are obtained within the constraints of the trip.

Factors and/or criteria such as those discussed above may be weighted or accounted for to optimize a plan for the trip. For example, in some embodiments, the list of elements and/or data associated with the factors above may be fed into a machine-learning algorithm. In an exemplary embodiment, satisfaction of the list and/or of constraints on the trip may be used to generate a reward function for a reinforcement learning model, and the list of elements, inventory, location information of entities, or the like may be fed as input data into the reinforcement learning model so as to train a policy usable to determine a plan for the trip. In another example, the smart-trip server system 135, an API system 118, or the like may apply a pathfinding algorithm, a map algorithm, or the like, e.g., that is configured to determine a route between various elements given various criteria. In an example, the smart-trip application may request directions for one or more options for a stage of the trip, e.g., from an API system 118 configured to generate map-based directions, and may select an option for the stage of the trip that best satisfies trip criteria. In a further example, the smart-trip application may determine that a cluster of elements are provided by a particular entity, designate the particular entity for a visit and remove the provided items for consideration, and then iterate the foregoing to identify one or more entities that provide the remaining elements. In another example, the smart-trip application may simulate many possible options for the trip, and then select an option that best satisfies the list and/or criteria for the trip.

In some embodiments, at least a portion of the directions generated as discussed above may be provided prior to or upon commencement of the trip. For example, the user device 105 may be caused to display directions to a first stop on the trip, e.g., from a current location of the user device 105 to a location of an entity identified for the trip. In some embodiments, directions for travel to or between entities may be provided as map-based transit directions. In some embodiments, directions within an entity may be provided as walking directions, via an interior map or schematic of the entity, or the like. Type and detail of directions may vary as the user 125 transitions from traveling to an entity to traveling at or within the entity.

At step 214, the smart-trip application may receive an indication from the user device 105 that the user device 105 has determined that the user 125 has arrived at an entity 130. In various embodiments, the determination of arrival of the user 125 by the user device 105 may be based on, for example, location information from a positioning sensor 145 of the user device 105 relative to a location of the entity 130, a connection of the user device 105 to a network 120 associated with the entity 130, a signal detected by a sensor 140 of the user device that is indicative of the entity 130 (e.g., an image, sound, or other signal), or the like.

At step 216, in response to receiving the indication that the user has arrived at the entity 130, the smart-trip application may cause the user device 105 to output directions to one or more locations at the entity 130 associated with one or more of the elements on the list. For example, as a user enters a hardware store, the user's phone may be caused to display walking directions within the hardware store that lead the user to the “gardening” aisle, which is predicted to have one of the elements on the user's list, e.g., a garden hose. The order at which the user 125 is directed to different elements within a particular entity, and the route for doing so, may be determined, e.g., via the optimization discussed above, so that the user 125 efficiently navigates through the entity. For example, the order and route may be determined so as to minimize a total amount of travel within the entity to acquire all of the elements on the list provided by that entity. In another example, the order and route may be determined to route the user 125 past or near a particular item, e.g., an item determined to be of interest to the user 125 or an item on sale or an the like. In another example, the order and route may be determined based on a likely inventory status of the items, e.g., so that an item that is more likely to go out of stock is prioritized.

In some embodiments, the smart-trip application, e.g., via the positioning sensor 145 of the user device 105, may be configured to determine a change in location of the user device 105. Further, in some embodiments, in response to determining such a change in location of the user device 105, the smart-trip application may be configured to update the directions. For example, a user may desire to acquire a garden hose and a power drill at a hardware store. The smart-trip application may be configured to direct the user to the location of the garden hose and, upon reaching that location, may be configured to update the directions to instead direct the user to a location of the power drill.

In some embodiments, the smart-trip application may be configured to update the directions in response to detecting that the user 125 has completed a stage of the trip. A “stage” of the trip may refer to, for example, acquisition of a particular element, acquisition of all elements to be obtained from a particular entity, arrival or departure to or from an entity, appointment, or destination, or the like. Updating the directions in response to detecting that the user 125 has completed a stage of the trip may include causing the user device 105 to display directions for a next stage of the strip. In various embodiments, the smart-trip application may be configured to detect completion of a stage of the trip based on one or more of (i) a comparison between a location of the user device 105 with the at least one location associated with an element (e.g., indicative that the user 125 has obtained the element), image data extracted from one or more images taken of the at least one element (e.g. taken by the user 125 via the sensor 140 in order to “check-off” the item, indicate that item should be skipped or is out of stock, or the like), or a user instruction received via the user device (e.g., indicative that the user 125 has obtained the element or completed the stage, or the like).

In some embodiments, the smart-trip application may be configured to track elements obtained by the user, e.g., via detecting completion of a stage of the trip, receiving receipt or transaction data from the user 125 or another source, or the like. In some embodiments, the smart-trip application may be configured to update the list based on the elements determined to be obtained during a trip.

In some embodiments, the smart-trip application may be configured to receive updates to a trip, e.g., via the GUI of the user device 105. Such updates may be provided at any suitable time such as, for example, prior to, during, or after a trip. Such updates may occur at regular intervals, in response to automatic push request, in response to a manual update request, etc. An update may include, for example, addition, modification, or removal of an element from the list, a change in a designation of an element as available for substitution, addition modification, or removal of a criterion for the trip, addition, modification, or removal of one or more other users from the trip.

In an exemplary embodiment, a user may add elements to the user's list to plan a grocery trip. Another user, e.g., a roommate, may add elements to their own list for a similar grocery trip. The user may add the other user to their trip, whereby the other user's list may be retrieved and added to the user's list to make a superset of the lists. The superset may then be subdivided over the user and the other user to plan an efficient execution of the trip. The smart-trip application may track which list each element originated from, e.g., in order to determine and or facilitate a balance of funds between the users.

It should be understood that embodiments in this disclosure are exemplary only, and that other embodiments may include various combinations of features from other embodiments, as well as additional or fewer features. For example, while some of the embodiments above pertain to a user login, any suitable activity may be used. In an exemplary embodiment, the identifying and validating operations discussed above may be used to determine a likelihood that the interaction is fraudulent or not. In an example, details of an interaction may be compared against user history and/or historical fraudulent interactions in order to predict whether an interaction is fraudulent.

In general, any process or operation discussed in this disclosure that is understood to be computer-implementable, such as the processes illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

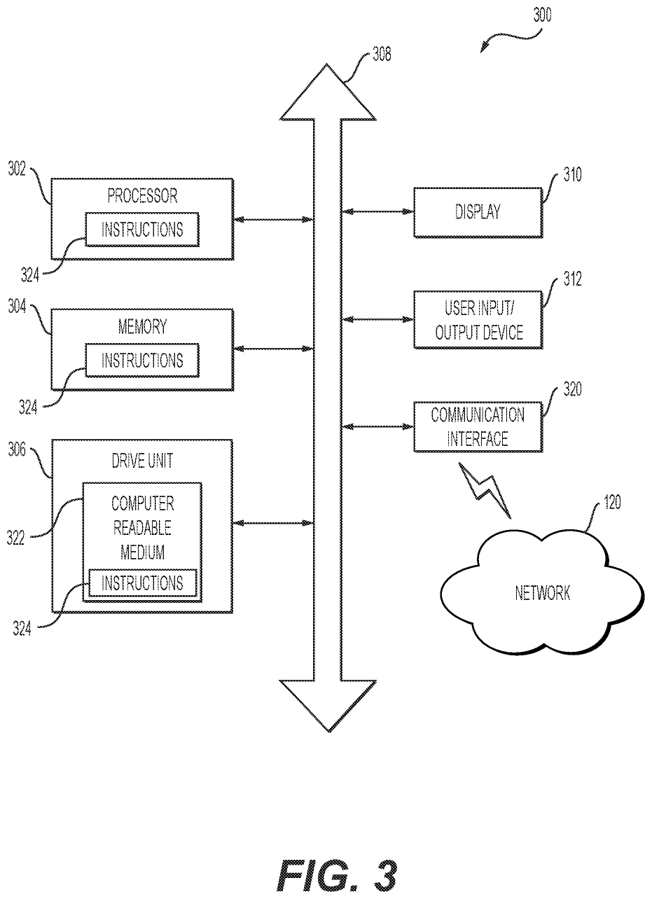

FIG. 3 is a simplified functional block diagram of a computer 300 that may be configured as a device for executing the methods of FIG. 2, according to exemplary embodiments of the present disclosure. For example, the computer 300 may be configured as the entity system 110, the user device 105, the smart-trip server system 135 and/or another system according to exemplary embodiments of this disclosure. In various embodiments, any of the systems herein may be a computer 300 including, for example, a data communication interface 320 for packet data communication via network 120. The computer 300 also may include a central processing unit (“CPU”) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 and/or computer readable medium 322). The computer 300 also may include input and output ports 312 and/or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for optimizing an in-person trip, comprising:
determining, via at least one processor and based on a user interaction between a user and a user device, that the user has an in-person-action intention associated with a particular location;
obtaining, via the at least one processor, a list of elements designated by the user for in-person action;
identifying, via the at least one processor, at least one entity associated with the particular location;
determining, via the at least one processor, at least one location at the at least one entity associated with at least one element on the list;
generating, via the at least one processor, directions that indicate a path through the at least one entity and to the at least one location associated with the at least one element;
receiving, via the at least one processor, an indication from the user device that the user device has determined that the user has arrived at the at least one entity; and
in response to receiving the indication, causing the user device to output the directions.

2. The computer-implemented method of claim 1, wherein the particular location is based on a current location of the user device determined via a positioning device associated with the user device.

3. The computer-implemented method of claim 2, further comprising determining the particular location based on one or more of a current direction of travel of the user device detected by the positioning device, user history data that includes data related to historical in-person trips of the user, or a user instruction received by the user device.

4. The computer-implemented method of claim 1, wherein the user interaction between the user and the user device includes one or more of:
a positioning device associated with the user device detecting that the user device is approaching the at least one entity;
the user device receiving a planning request from the user for an in-person trip at a current time; or
the user device receiving a planning request from the user for an in-person trip at one or more of a user-specified time or a user-specified location.

5. The computer-implemented method of claim 1, further comprising:
in response to determining a change in location of the user device, causing the user device to update the directions.

6. The computer-implemented method of claim 1, wherein:
in response to determining that the user has completed a stage of the in-person trip, causing the user device to update the directions to display a next stage of the in-person trip;
completion of the stage of the in-person trip is determined based on one or more of:
a comparison between a location of the user device with the at least one location associated with the at least one element;
image data extracted from one or more images taken of the at least one element; or
a user instruction received via the user device; and
the next stage of the in-person trip includes one or more of:
a next element of the at least one elements;
a next entity of the at least one entity; or
a conclusion of the in-person trip.

7. The computer-implemented method of claim 1, wherein the list of elements is obtained from one or more of (i) an online universal element listing associated with the user or (ii) element listing data included in an electronic application user profile associated with the user.

8. The computer-implemented method of claim 1, wherein the at least one entity is identified based on a comparison of the list of elements with one or more of (i) inventory information for the at least one entity or (ii) item category information for the at least one entity.

9. The computer-implemented method of claim 8, further comprising:
determining one or more similar elements that correspond to one or more elements in the list of elements;
wherein the comparison of the list of elements with the inventory information for the at least one entity takes into account the one or more similar elements.

10. The computer-implemented method of claim 1, wherein one or more of the identifying of the at least one entity or the directions is optimized based on one or more of:
minimizing a total predicted trip time;
a maximum constrain on the total predicted trip time;
minimizing a total predicted trip distance;
minimizing a total predicted trip cost;
minimizing a total number of entity visits in the in-person trip;
maximizing a total number of elements from the list of elements included in the in-person trip; or
one or more user-selected destinations to be included in the in-person trip.

11. The computer-implemented method of claim 1, wherein the at least one location associated with the at least one element is based on an element category associated with the at least one element and on a location at the at least one entity associated with the element category.

12. The computer-implemented method of claim 1, wherein the at least one location associated with the at least one element is determined based on one or more of element location information provided by the at least one entity or crowd-sourced element location information.

13. A computer-implemented method for optimizing an in-person trip, comprising:
detecting, via at least one processor of a user device, an interaction between a user and the user device indicative that the user has an in-person action intention associated with a particular location;
transmitting, via the at least one processor and to a server system, an indication of the detecting of the interaction;
receiving, from the server system, directions that indicate a path through at least one entity associated with the particular location and to at least one location associated with at least one element from a list of elements designated by the user for in-person action;
detecting, via the at least one processor, that the user has arrived at the at least one entity; and
in response to detecting that the user has arrived, causing a display of the user device to output the directions.

14. The computer-implemented method of claim 13, wherein the particular location is based on one or more of a current location of the user device determined via a positioning device associated with the user device, a current direction of travel of the user device detected by the positioning device, user history data that includes data related to historical in-person trips of the user, or a user instruction received by the user device.

15. The computer-implemented method of claim 13, wherein the user interaction between the user and the user device includes one or more of:
a positioning device associated with the user device detecting that the user device is approaching the at least one entity;
the user device receiving a planning request from the user for an in-person trip at a current time; or
the user device receiving a planning request from the user for an in-person trip at one or more of a user-specified time or a user-specified location.

16. The computer-implemented method of claim 13, further comprising:
determining, via the at least one processor, a change in location of the user device; and
updating, via the at least one processor, the directions in response to determining the change in location of the user device.

17. The computer-implemented method of claim 13, further comprising:
in response to determining that the user has completed a stage of the in-person trip, updating the directions to display a next stage of the in-person trip, wherein:
determining the completion of the stage of the in-person trip is determined based on one or more of:
a comparison between a location of the user device with the at least one location associated with the at least one element;
image data extracted from one or more images taken of the at least one element; or
a user instruction received via the user device; and
the next stage of the in-person trip includes one or more of:
a next element of the at least one elements;
a next entity of the at least one entity; or
a conclusion of the in-person trip.

18. The computer-implemented method of claim 13, wherein the list of elements is obtained from one or more of (i) an online universal element listing associated with the user or (ii) element listing data included in electronic application data on the user device.

19. The computer-implemented method of claim 13, wherein the at least one entity is identified based on a comparison of (i) one or more of the list of elements, or one or more similar elements that correspond to one or more elements in list of elements with (ii) one or more of inventory information for the at least one entity, or item category information for the at least one entity.

20. A computer-implemented method for optimizing an in-person trip, comprising:
determining, via at least one processor and based on a user interaction between a user and a user device, that the user has an in-person-action intention associated with a particular location;
obtaining, via the at least one processor, a list of elements designated by the user for in-person action, wherein the list of elements is obtained from one or more of (i) an online universal element listing associated with the user or (ii) element listing data included in an electronic application user profile associated with the user;
identifying, via the at least one processor, at least one entity associated with the particular location, wherein one the identifying of the at least one entity is optimized based on one or more of:
minimizing a total predicted trip time;
a maximum constrain on the total predicted trip time;
minimizing a total predicted trip distance;
minimizing a total predicted trip cost;
minimizing a total number of entity visits in the in-person trip;
maximizing a total number of elements from the list of elements included in the in-person trip; or
one or more user-selected destinations to be included in the in-person trip; and
determining, via the at least one processor, at least one location at the at least one entity associated with at least one element on the list;
generating, via the at least one processor, directions that indicate a path through the at least one entity and to the at least one location associated with the at least one element;
receiving, via the at least one processor, an indication from the user device that the user device has determined that the user has arrived at the at least one entity; and
in response to receiving the indication, causing the user device to output the directions.
